(19) United States
(12) Patent Application Publication
(10) Pub. No.: US 2007/0030328 A1
(43) Pub. Date: Feb. 8, 2007

(54) Apparatus and method for multichannel sequence transmission and control

(76) Inventors: Feng-Yi Tai, Chung-Ho City (TW); Kuo-Jen Lien, Chung-Ho City (TW)

Correspondence Address: Connolly Bove Lodge & Hutz, LLP, P.O. Box 2207, Wilmington, DE, 19899-2207, US

(21) Appl. No.: 11/196,058

(22) Filed: Aug. 3, 2005

(51) Int. Cl. B41J 2/32

(52) U.S. Cl. 347/171

(57) ABSTRACT

Disclosed is an apparatus and a method for multichannel sequence transmission and control. The apparatus comprises a DMA generator, a bus interface, a data generator, a control unit, and a strobe signal generator. The DMA generator is coupled to the bus interface and the data generator, and operates in coordination with the control unit and the strobe signal generator. A step of initial set is that an external microcontroller controls the control unit via the bus interface to generate a TPH shift clock and a TPH latch signal necessary for a printhead. A step of transmitting data is that the DMA generator controls a printing data to transmit to the data generator for buffering and to move to a latch register according to the TPH latch signal; and a multiplexer outputs a combination of strobe signals set by the strobe signal generator to the printhead. A step of heating the printhead is to heat the printhead according to the strobe signals for printing and finish printing a printing data after the end of the strobe signals.

### BACKGROUND OF THE INVENTION

1. Field of the Invention

The present invention relates to an apparatus and a method for multichannel sequence transmission and control, and more particularly to a print control of data transmission for a thermal-wax transfer printer or a thermo-printer.

2. Description of the Prior Art

Due the popularization of digital image products and developments of products and inks relative to printing, users are easy to print by a general printer out a photograph whose quality is close to the developed photographs. The color printers available in the market are classified into colored ink jet printer, colored laser printer, and thermal-wax transfer printer. The paper printed by ink jet printer is easy muddied by water, and so the image printed in the paper is smudged. Furthermore, a printing speed of the ink jet printer is slower. The quality and speed of the laser printer are better than that of the ink jet printer, but the price of laser printer and the cost for printing is too high for general users. The printing speed of thermal-wax transfer printer is better, and the photograph has a good printed quality and a water-resistant coating. Moreover, the printed cost is cheaper, and so this has become the mainstream in the printer market.

The data-transmission and printing method of the conventional thermal-wax transfer printer will be described in the following. First, the contents desired to print, comprising words, pictures, are transmitted in line/row-based transmission method controlled by an external microcontroller, such as CPU or MCU, to a shift register into a printhead in sequence. Next, the line/row-based contents in the shift register are transmitted to latch register to store via a latch signal set by a control unit. Plural heating units corresponding to the latch register are activated by strobe signals generated by a strobe signal generator and then heat respective color dyes of the ribbon onto a surface of printed media, such as paper or photographic paper. Predetermined line/row content is printed through the colors dyes of ribbon, and then the printed paper is moved by a rotating axle to the next line and so the printing process of “one line” is completed. The printing process is performed repeatedly for printing content onto the surface of the printed media. However, as data-transmission and printing method described above, the complete data-transmission and control are directly controlled by the external microcontroller. Therefore, the data transmission, printing speed and quality are directly decided upon the ability of data process of the microcontroller.

In addition, a structure of the thermal-wax transfer printer mentioned above has a main key device of thermal-wax transfer printhead that employs plural heating units therein to heat a color ribbon for sublimating dyes and generating an image on a surface of the printed media. The heating unit is a thermal resistor, heats to rise temperature whiling the current being flowing therein and cools when the current stopped. Therefore, thermal-wax transfer printer is to perform a printing action with the characteristic of the thermal resistors mentioned above.

The ribbon applied in the thermal-wax transfer printer is a stable solid state at room temperature and is sublimated to vaporize when the temperature is higher than a threshold temperature, wherein the ribbon comprises a plurality of color regions arranged sequentially; each has different color dyes thereon. The amount of dyes transferred onto the printed media is based on a vaporized duration of the dyes, and the amount of dyes is higher and the gray level of color is deep. Hence, to achieve a preferred printing quality has to heat the ribbon over the threshold temperature for a space. Unfortunately, the heating unit has an upper temperature limit, and so the heating unit heats to rise temperature faster in the initial and may be broken when the temperature is over the upper temperature limit, as shown in FIG. 1.

### SUMMARY OF THE INVENTION

A main objective of the present invention is to provide an apparatus and a method for multichannel sequence transmission and control for a thermal-wax transfer printer or a thermo-printer.

Another main objective of the present invention is to provide an apparatus and a method for multichannel sequence transmission and control, in which a DMA generator is coupled to a bus interface and a data generator. Therefore, the data designated to print is directly transmitted via memory and it decreases the loading to control a printhead of a microcontroller and raises the printing quality and speed.

Still another main objective of the present invention is to provide an apparatus and a method for multichannel sequence transmission and control, in which heating units perform the heating repeatedly in a temperature range between an upper temperature limit and a temperature close to a vaporizing temperature of dyes of color ribbon by controlling the heating pulse of the heating units of the printhead.

Hence, the present invention discloses an apparatus for multichannel sequence transmission and control, which is coupled between an external microcontroller and a printhead. The apparatus comprises a bus interface, a DMA generator, a control unit, a strobe signal generator, and a data generator. The bus interface is coupled to an external microcontroller to obtain an instruction and information that are transmitted to each unit which is coupled to the bus interface. The DMA generator requests a DMA controller to operate according to a state of data buffer region of the data generator and generates a corresponding event interrupt signal according to an interrupt control register. The control unit generates a TPH shift clock and a TPH latch signal for controlling a data transmission frequency of the printhead according to an external clock signal of the external microcontroller. The strobe signal generator generates and sets strobe signals for controlling a heating of the printhead. The data generator temporarily stores a printing data controlled to write therein by one of the external microcontroller and the DMA generator, and transmits the printing data to a latch register of the printhead for printing according to the TPH latch signal.

The present invention also discloses a method for multichannel sequence transmission and control applied with an apparatus comprising a DMA generator, a bus interface, a data generator, a control unit, and a strobe signal generator. The method comprises:

a step of initial set, an external microcontroller controlling a control unit via the control unit to generate a TPH shift clock and a TPH latch signal necessary for a printhead;

a step of transmitting data, the DMA generator controlling a printing data to transmit to the data generator for buffering and to move to a latch register according to the TPH latch signal; and

a step of heating the printhead, a multiplexer activating heating units of the printhead according to a combination output generated the strobe signal generator to heat color ribbon to print, and finishing printing the printing data after an end of the strobe signals.

In one preferred embodiment of the present invention, the TPH shift clock generated by the control unit is a frequency of an external clock, provide by said external microcontroller, divided by a value set by the latch register.

In another preferred embodiment of the present invention, the strobe signals generated by the strobe signal generator have a signal period and a signal interval set according to various demands.

In still another preferred embodiment of the present invention, the data generator has a FIFO data buffer and is coupled to data pins of the printhead to transmit printing data in accordance with stored sequence.

### BRIEF DESCRIPTION OF THE DRAWINGS

FIG. 1 is a heating curve diagram of a heating unit in the conventional arts;

FIG. 2 is structural block of the present invention;

FIG. 3 is an assembly diagram of a multiplexer in a strobe signal generator of the present invention;

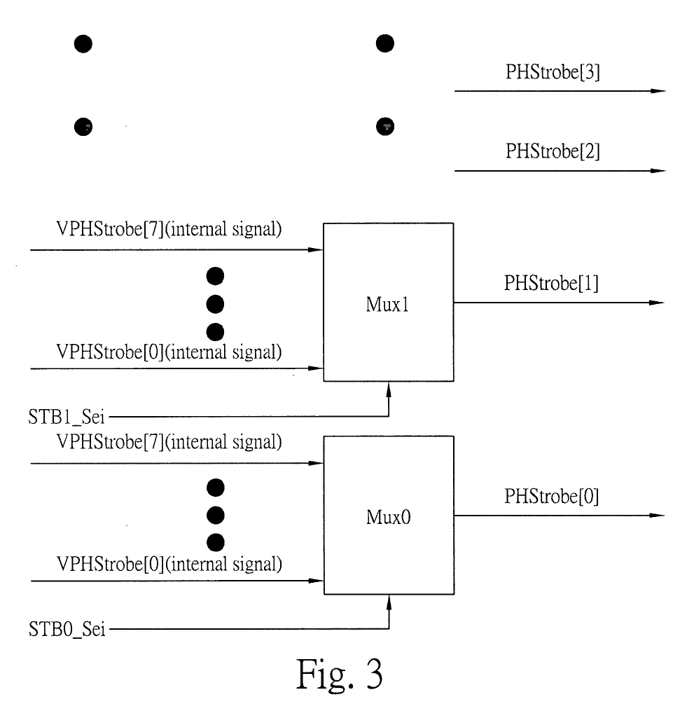

FIG. 4 is a connecting diagram among a strobe signal register, a virtual strobe signal register, and a printhead in the present invention;

FIG. 5 is a heating curve diagram with heating pulses in one preferred embodiment of the present invention; and

FIG. 6 is a diagram of heating pulses in the preferred embodiment of the present invention;

### DESCRIPTION OF THE PREFERRED EMBODIMENT

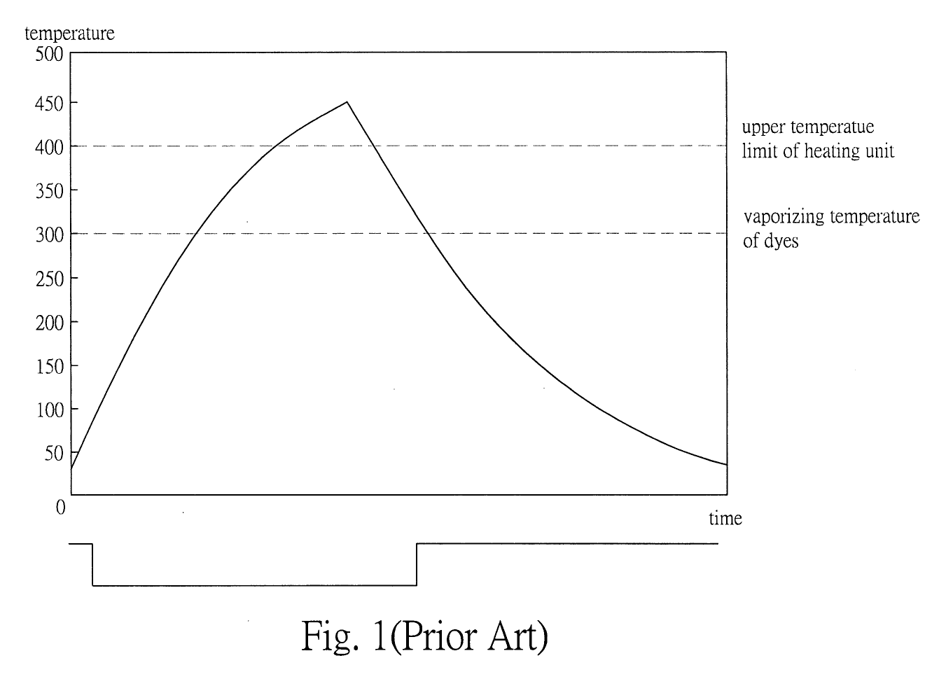

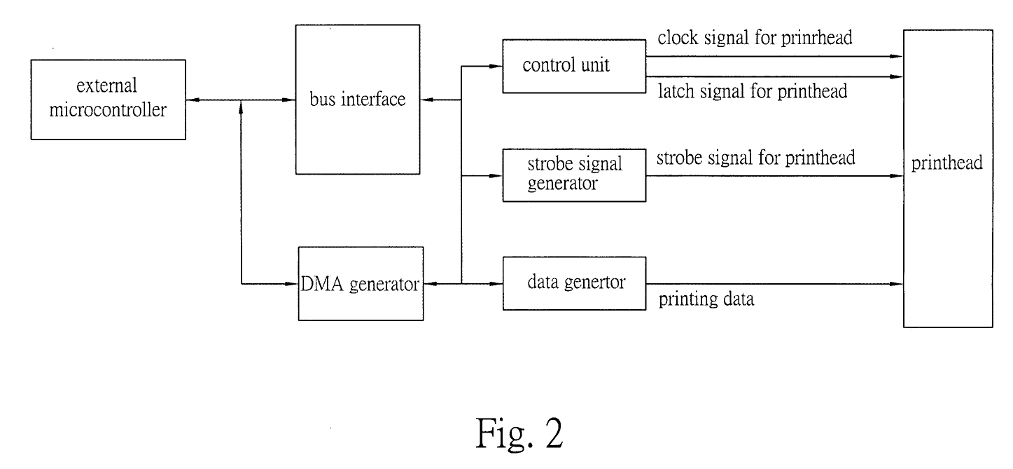

Referring to FIG. 2, it is a structural block of an apparatus and a method for multichannel sequence transmission and control in the present invention. As shows in FIG. 1, the apparatus comprises a bus interface 1, a DMA generator 2, a data generator 3, a control unit 4, and a strobe signal generator 5. The bus interface is coupled to an external microcontroller 6 to obtain a control instruction for printing. Signal output pins of the data generator 3, the control unit 4 and the strobe signal generator 5 are respectively coupled to a printhead 7 of a printer for transmitting printing data and controlling the printing action. Therefore, this is couple of controlling the heating pulse by division and high printing efficiency, and so to extend the service life and decrease the power consumption. The apparatus of the present invention could be applied to any thermal-wax transfer printer or thermo-printer.

At least one input pin of the bus interface 1 is coupled to the external microcontroller 6 to obtain an instruction and information that are transmitted to the DMA generator 2, the data generator 3 and a strobe signal generator 4 which are coupled to the bus interface 1 to perform a corresponding action and set.

The DMA generator 2 requests a DMA controller (not shown) thereof to perform a DMA service according to a state of FIFO (fast input fact output) data buffer region (not shown) of the data generator, and handles a signal of DMA acknowledge handshake generated by the DMA controller. In addition, the DMA controller can generate a corresponding event interrupt signal according to an instruction of interrupting control register.

The data generator 3 has a FIFO data buffer region (not shown) to temporally store a designated data controlled to write in by the external microcontroller 6 or the DMA controller 2. The designated data is transmitted to a latch register 7 for printing according to a control instruction of a TPH latch signal generated by the control unit 4.

The control unit 4 generates a TPH shift clock and the TPH latch signal for controlling a data transmission frequency of the printhead according to an external clock signal transmitted by the external controller 6. The TPH shift clock is pulse signal having a frequency of the external clock, provide by the external microcontroller 6, divided by a value set by said latch register.

The strobe signal generator 5 generates strobe signals for controlling a heating of the printhead 7, and the strobe signals are set to form plural sequential and different strobe signals for controlling a heating of the printhead 7.

The strobe signal generator 5 generates plural different virtual strobe signals according to various demands, and the virtual strobe signals can corresponds to the same or different amount of strobe signals, each strobe signals having a signal period and a signal interval set according to various demands. The virtual strobe signals and actual strobe signals are combined via a multiplexer 8 to make plural heating units (not shown) of the printhead 7 have a heating time with flexible adjustment and set.

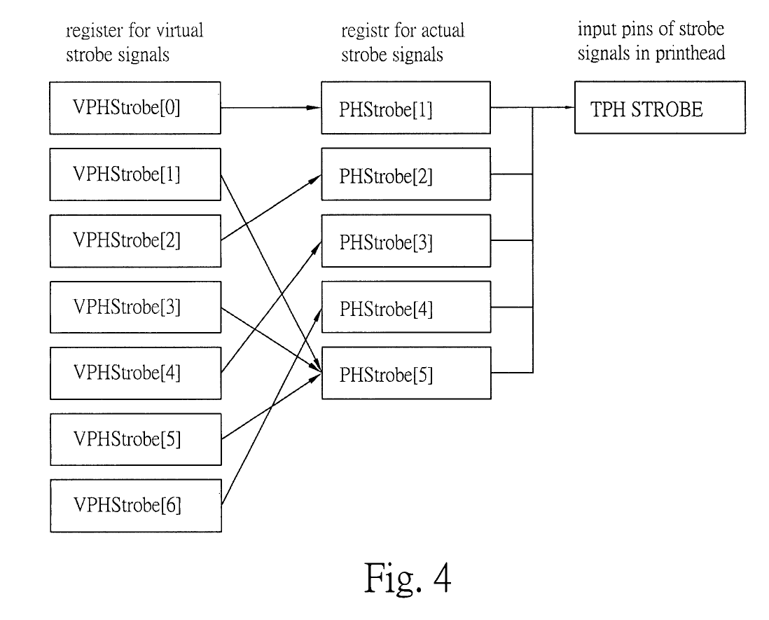

That is to say, the present invention can control the output of the actual strobe signals for controlling the heating time of the heating units via the combination of the virtual strobe signals and the actual strobe signals. As shown in FIG. 4, there are seven virtual strobe signals, which comprises VPHStrobe[0]˜VPHStrobe[6], and five actual strobe signals, which comprises PHStrobe[1]˜PHStrobe[5]. The actual five strobe signals of PHStrobe[1]˜PHStrobe[5] is coupled to the same pin of strobe signal input in the printhead 7. The virtual strobe signals of VPHStrobe[0], [2], [4] and [6] are respectively connected to the actual strobe signals of PHStrobe[1]˜PHStrobe[4], and the virtual strobe signals of VPHStrobe[1], [3], and [5] are connected to he actual strobe signal of PHStrobe[5]. The signal intervals of the virtual strobe signals VPHStrobe[0]VPHStrobe[6] in the register are 5, 1, 5, 1, 5, 1, 5. The heating process is automatically performed four times, and is suspended for 1 time unit after heating for 5 time units. Therefore, the present invention can be easy to divide the heating time to form heating pulses for controlling the heating process and making various heating effect. The service life is extended and the power consumption is decreased. Moreover, the heating process is automatically been performing without loading of the microcontroller.

The present invention is suitable to any thermal-wax transfer printer or thermo-printer for multichannel sequence transmission and control. The present invention mainly the apparatus of multichannel sequence transmission and control to reduce the loading of the external microcontroller 6 for promoting the printing speed by cooperating to directly transmit the printing data with the DMA generator 2 while transmitting and printing the printing data. The strobe signal generator 5 control the heating pulse to form various heating effect for extending the service life and decreasing the power consumption.

The method for multichannel sequence transmission and control will be described below.

In a step of initial set, the external microcontroller 6 controls the control unit 4 via the bus interface 1 to generate the TPH shift clock and the TPH latch signal necessary for a printhead. The set step is only performed once after turning on the apparatus, and the apparatus generates a pulse signal necessary for the printhead 7 according to the external clock signal provided by the external microcontroller 6 when the set step is finished.

Next, in a step of transmitting data, a data address and a data length of the oncoming to be printed line of the printing data is designated to activate the DMA generator 2. Then, the DMA generator 2 is performed and automatically transmits the printing data to the FIFO buffer region of the data generator 3. After the data transmission is finished, the control unit 4 automatically generates the TPH latch signal and transmits the data stored in the FIFO buffer region to the latch register of the printhead 7 for an appropriate duration that is time of the printhead 7 accepting the latch signal and moving the printing data to the latch register.

In a step of heating the printhead, the signal period and signal interval of each strobe signals in the strobe signal generator 5 is set, and a setting value of the multiplexer 8 is set according to the actual layout of the printhead 7. The multiplexer 8 combines the strobe signals generated by the strobe signal generator 5 to transmit to the printhead 7. After the action mentioned above is finished, the heating units are activated with the heating time and interval according to the strobe signals generated by the strobe signal generator 5. The heating units are controlled to heat color ribbon to sublimate the color dyes for printing, and the printing of the printing data is finished after the end of the strobe signals.

The control unit 4 generates the TPH strobe signal to transmit the data to the latch register of the printhead 7. If the printhead is still in the last printing action, the latch signal automatically be delayed until the printhead 7 finishes the heating for the last printing.

### Embodiment

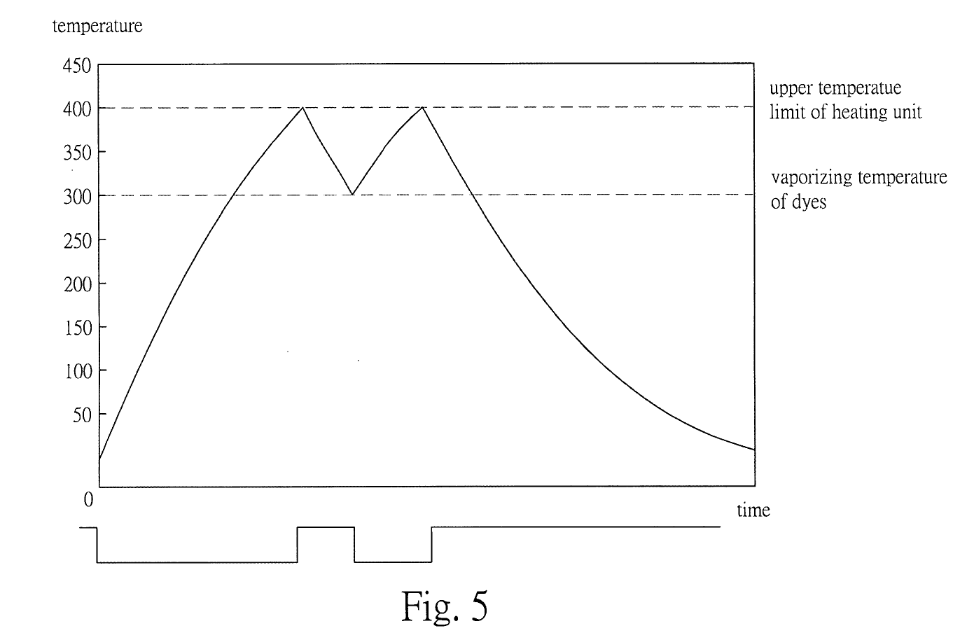

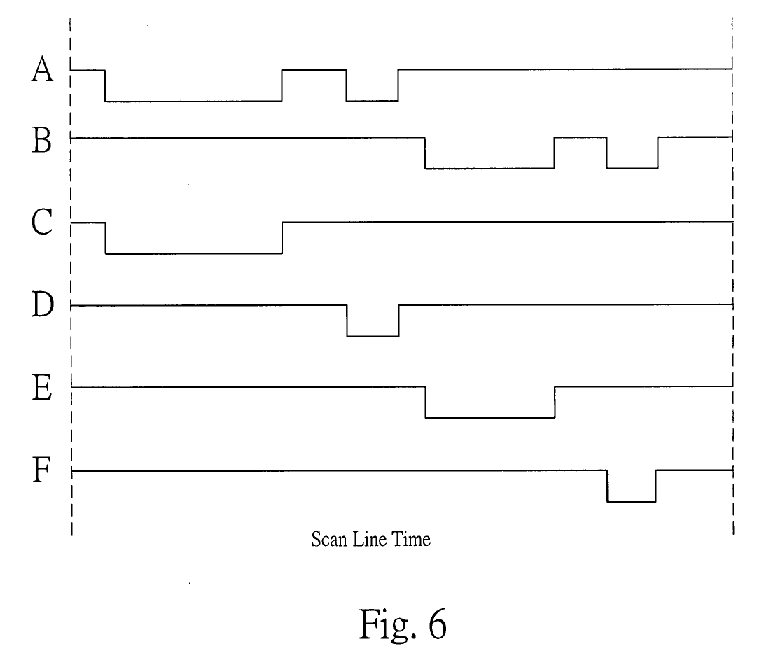

Referring to FIGS. 5 and 6, they are respectively a heating curve diagram with heating pulses and a diagram of heating pulses. As shown in FIGS. 5 and 6, the printhead of the thermal-wax transfer printer is set with 1344 heating units and two pin for inputting the strobe signals. The strobe signal A controls the 1^{st}˜576^{th} heating units, and the strobe signal B controls the 577^{th}˜1344^{th} heating units. In the embodiment, the waveform of the pulse X, as shown in FIG. 5, the temperature keeps between the upper temperature limit and the vaporizing temperature of dyes with plural times of heating and cooling of the heating units. Therefore, the heating effect varies with pulse heating for extending the service life and decreasing the power consumption.

In addition, FIG. 6 shows a diagram of heating pulses desired to generate in the embodiment of the present invention. The strobe signal A of the printhead has to generate as the heating pulse of Line A, and the strobe signal B of the printhead has to generate as the heating pulse of Line B. For generating the two heating pulses, the strobe signal generator 5 is set to generate four heating pulses of Line C D E, F shown in FIG. 6, and the multiplexer 8 is set to output the first and second strobe signals into the input pin of the strobe signal A in the printhead 7 and to output the third and fourth strobe signals into the input pin of the strobe signal B in the printhead 7. Therefore, the desired heating pulses to perform the heating action of the heating units mention above are obtained.

Although specific embodiments have been illustrated and described, it will be obvious to those skilled in the art that various modifications may be made without departing from what is intended to be limited solely by the appended claims.

What is claimed is:

1. An apparatus for multichannel sequence transmission and control, which is applied to print control of data transmission for a thermal-wax transfer printhead or thermo-printhead, and coupled between an external microcontroller and a printhead, said apparatus comprising:
a bus interface coupled to said external microcontroller to obtain an instruction and information that are transmitted to a DMA generator, a data generator and a strobe signal generator which are coupled to said bus interface to perform a corresponding action and set said DMA generator requesting a DMA controller to perform a control of data transmission according to a state of data buffer region of said data generator, handling a signal of DMA acknowledge handshake generated by said DMA controller, and generating a corresponding event interrupt signal according to an interrupt control register;
said control unit generating a TPH shift clock and TPH latch signal for controlling a data transmission frequency of said printhead according to an external clock signal; and
a strobe signal generator generating and setting strobe signals for controlling a heating of said printhead;
a data generator temporarily storing a printing data controlled to write therein by one of said external microcontroller and said DMA generator, transmitting said printing data to a latch register of said printhead for printing according to said TPH latch signal.

2. The apparatus according to claim 1, wherein said TPH shift clock generated by said control unit is a frequency of an external clock, provide by said external microcontroller, divided by a value set by said latch register.

3. The apparatus according to claim 1, wherein said strobe signals generated by said strobe signal generator have a signal period and a signal interval set according to various demands to form plural sequential and different strobe signals for controlling a heating of said printhead with various heat pulses.

4. The apparatus according to claim 1, wherein said strobe signal generator further comprises at least one strobe signal input pin that generates plural different virtual strobe signals according to demands to from varied combination of said virtual strobe signals and said strobe signals transmitted to said printhead.

5. The apparatus according to claim 4, wherein said strobe signal generator further comprises a multiplexer to set a connection of each virtual strobe signal and said strobe signal and generate different combination output of sequence strobe signals as a input signal of said least one strobe signal input pin.

6. The apparatus according to claim 1, wherein said data generator has a FIFO data buffer and is coupled to data pins of said printhead to transmit printing data in accordance with stored sequence.

7. A method for multichannel sequence transmission and control applied to a thermal-wax transfer printer or a thermo-printer via an apparatus comprising a DMA generator, a bus interface, a data generator, a control unit, and a strobe signal generator, said method comprising:
a step of initial set, an external microcontroller controlling a control unit via said bus interface to generate a TPH shift clock and a TPH latch signal necessary for a printhead;
a step of transmitting data, said DMA generator controlling a printing data to transmit to said data generator for buffering and to move to a latch register according to said TPH latch signal; and
a step of heating said printhead, activating heating units of said printhead, controlling printhead to heat color ribbon to print according to a combination output generated said strobe signal generator and finish printing said printing data after an end of said strobe signals.

8. The method according to claim 7, wherein said step of transmitting data further comprising:
said control unit automatically generating a TPH latch signal for an appropriate duration after said printing data is transmitted into a data buffer region of said data generator, for controlling said printing data stored in said data buffer region to transmit to said latch register of said printhead.

9. The method according to claim 8, wherein said appropriate time is time of said printhead accepting said latch signal and moving said printing data to said latch register.

10. The method according to claim 8, wherein said control unit automatically delays to generate a TPH strobe signal after a heating of said printhead in last printing process is finished.

11. The method according to claim 7, wherein said step of heating said printhead further comprising:
setting a signal period and a signal interval of said strobe signals generated by said strobe register to make a multiplexer combine said strobe signals to output into said printhead to heat color ribbon for printing.
